(19) United States
(12) Patent Application Publication
(10) Pub. No.: US 2008/0187709 A1
(43) Pub. Date: Aug. 7, 2008

(54) PLACEMAT WITH TOY HOLDER(S) AND/OR ATTACHMENT DEVICE(S)

(76) Inventors: Lauren K. Hester, Ashburn, VA (US); Nina Z. Smith, Ashburn, VA (US)

Correspondence Address: KED & ASSOCIATES, LLP, P.O. Box 221200, Chantilly, VA, 20153-1200, US

(21) Appl. No.: 11/856,915

(22) Filed: Sep. 18, 2007

Related U.S. Application Data
(60) Provisional application No. 60/899,621, filed on Feb. 6, 2007.

(51) Int. Cl. B32B 3/06

(52) U.S. Cl. 428/99

(57) ABSTRACT

A placemat configured to protect a tabletop is provided, which includes a main body having a front surface and a rear surface configured to be placed in contact with a table top, and one or more toy holders attached to the front surface and configured to hold one or more toys. The placemat may further include one or more attachment devices provided on the rear surface configured to secure the placemat in place on the table top.

### BACKGROUND

1. Field

A placemat with toy holder(s) and/or attachment device(s) is disclosed herein.

2. Background of the Related Art

Infant/toddler placemats exist. However, in their current form they only serve to protect the table.

### SUMMARY OF THE INVENTION

An object is to solve at least the above problems and/or disadvantages and to provide at least the advantages described hereinafter.

A placemat with toy holder(s) and/or attachment device(s) according to embodiments is disclosed herein.

Additional advantages, objects, and features will be set forth in part in the description which follows and in part will become apparent to those having ordinary skill in the art upon examination of the following or may be learned from practice. The objects and advantages may be realized and attained as particularly pointed out in the appended claims.

### BRIEF DESCRIPTION OF THE DRAWINGS

Embodiments will be described in detail with reference to the following drawings in which like reference numerals refer to like elements, and wherein:

FIG. 1 is a view of a front surface of a placemat with toy holder(s) and/or attachment device(s) according to an embodiment;

FIG. 2 is a view of a rear surface of the placemat of FIG. 1;

FIG. 3 shows the placemat of FIGS. 1-2 attached to an exemplary table;

FIG. 4 is a view of a front surface of a placemat with toy holder(s) and/or attachment device(s) according to another embodiment;

FIG. 5 is a view of a rear surface of the placemat of FIG. 3;

FIG. 6 shows the placemat of FIGS. 4-5 attached to an exemplary table; and

FIGS. 7A-11C are partial views (circle A in FIG. 1) of front surfaces of placemats having various style toy holder(s).

### DETAILED DESCRIPTION

Children's placemats have been designed for functional purposes only. In other words, they have been designed to protect tables from spills and to protect children from unsanitary tables at restaurants. However, many times when children eat at restaurants they can become restless and want to play with toys. Many times the toys end up on the floor and become dirty and parents do not want their children to play with the toys any longer. The placemat with toy holder(s) and/or attachment device(s) according to the embodiments disclosed herein would allow children to play with toys while waiting for the meal to arrive, while other people at the table are eating, or after a meal is finished. The placemat with toy holder(s) and/or attachment device(s) according to embodiments disclosed herein minimizes the risk of dropping toys on the floor. It also helps to entertain the child so adults can converse and enjoy their meal.

As set forth above, infant/toddler placemats exist but generally only serve to protect a table. The placemat with toy holder(s) and/or attachment device(s) according to embodiments disclosed herein allow for children to be in restaurants without having to touch an unsanitary table. The placemat with toy holder(s) and/or attachment device(s) according to embodiments disclosed herein is designed to allow for the attachment of one or more toy(s) or other items thereto, as well as to protect the table. Further, the placemat with toy holder(s) and/or attachment device(s) according to embodiments disclosed herein allows for children to attach one or more toy(s) thereto, and gives them the ability to play with those toy(s) without parents worrying about the toy(s) falling on the floor and becoming dirty. The placemat with toy holder(s) and/or attachment device(s) according to embodiments disclosed herein helps provide entertainment for the child so the adults can enjoy their meal.

The placemat with toy holder(s) and/or attachment device(s) according to embodiments disclosed herein may include a main body with front and rear surfaces being designed to be placed in contact with a table top. One or more toy holder(s) may be attached to the front surface. The one or more toy holder(s) may be loops, ties, ribbons, Velcro, buttons, retractable tabs, or other fastening devices.

Further, one or more attachment device(s) may be attached to the rear surface. The attachment device(s) may be one or more suctions cup(s). Alternatively, sticky backing and/or double sided tape may be utilized.

Further, the placemat with toy holder(s) and/or attachment device(s) according to embodiments disclosed herein may wrap around to protect the side/edge of the table in addition to the tabletop. Alternatively, the placemat with toy holder(s) and/or attachment device(s) according to embodiments disclosed herein may include a pocket which hangs down from the table top. Further, the attachment device(s) may be disposed on the rear surface which allow for the placemat to remain in place during mealtime.

The placemat with toy holder(s) and/or attachment device(s) according to embodiment disclosed herein may be disposable. The disposable sanitary placemat with toy holder(s) and/or attachment device(s) will allow for parents to discard the placemat after use so as to not have to worry about toting another item. The disposable version may be made of a durable, absorbent material. The disposable version may have at least one pocket(s) placed anywhere on the placemat. The placemat may also have at least one toy holders(s) placed anywhere on the mat. The toy holder(s) may be in the form of one or more loop(s) and may be made of an elastic material that will allow give when pulled upon. The disposable placemat may have self adhesive tabs to act as fasteners. For example, four self adhesive tabs may be provided on the corners of the rear surface of the main surface or one long adhesive strip may be located along the entire length of the top and bottom portion of the placemat. The adhesive will not ruin table finish or alter the condition of the table to which it adheres. The disposable mat may also have a pocket at the bottom of the placemat to catch food or other spills. Further, the disposable version may be absorbent on top but have a backing which does not allow liquid to seep through to the table.

The placemat with toy holder(s) and/or attachment device(s) according to embodiments disclosed herein needs to be durable enough to allow a child to pull the toy holder(s) without ripping or otherwise damaging the placemat. The placemat with toy holder(s) and/or attachment device(s) according to embodiments disclosed herein may be made of a durable, non-absorbent material which can be wiped down and disinfected after each use. The placemat with toy holder(s) and/or attachment device(s) according to embodiments disclosed herein may be made of a material coated with a protective layer. The placemat with toy holder(s) and/or attachment device(s) according to embodiments disclosed herein may be made using any design of material that can be disinfected. The placemat with toy holder(s) and/or attachment device(s) according to embodiments disclosed herein may also be made of a material that can be placed in the washing machine.

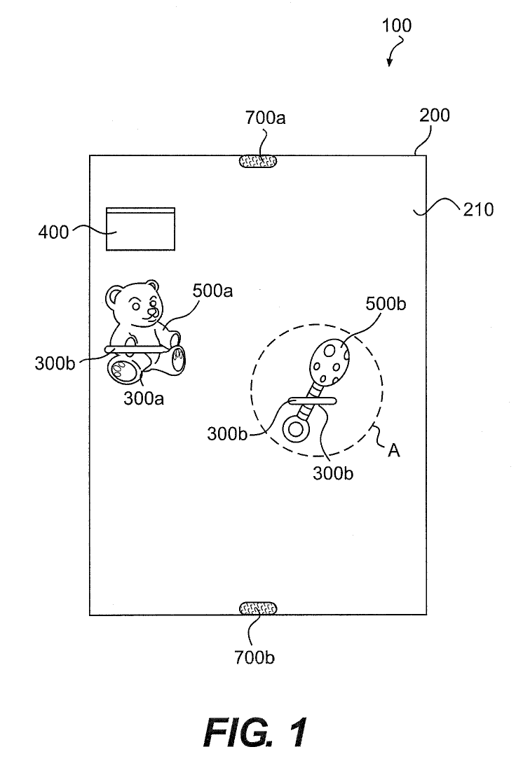

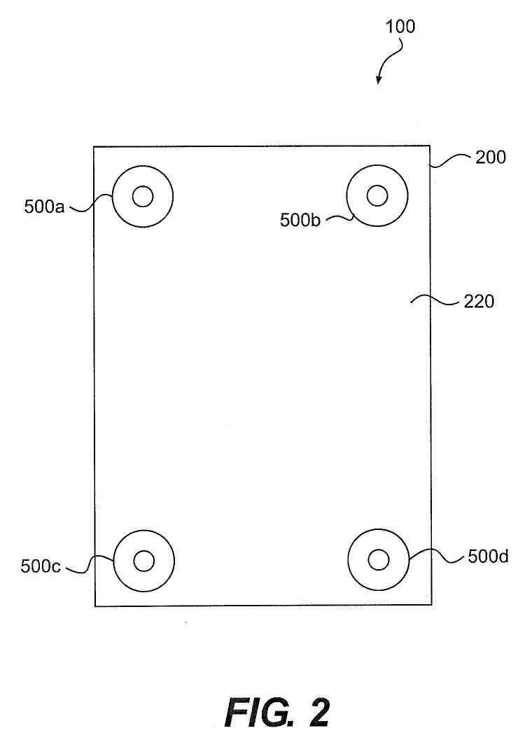

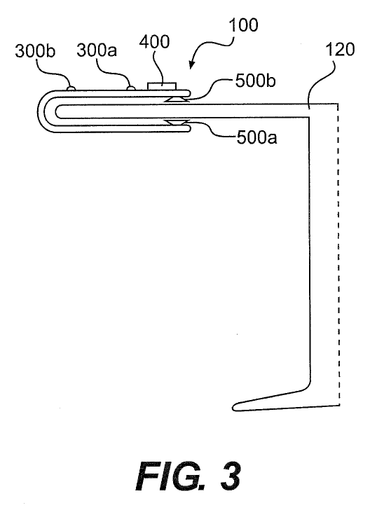

FIG. 1 is a view of a front surface of a placemat with toy holder(s) and/or attachment device(s) according to an embodiment. FIG. 2 is a rear surface view of the placemat of FIG. 1. FIG. 3 shows the placemat of FIGS. 1-2 attached to an exemplary table. Referring to FIG. 1, the placemat 100 includes a main body having a front surface 210 and a rear surface 220. The placemat 100 may be long enough to cover the dining area of a table 120 for a child. Further, the placemat 100 may be configured to fold to the underside of the table 120, thus covering a side/edge of the table 120, as shown in FIG. 3.

In the embodiment of FIGS. 1-2, the placemat 100 is rectangular in shape; however, other shapes may be appropriate and/or desirable. Further, in the embodiment of FIGS. 1-2, the placemat 100 has measurements of ˜20 inches in width and ˜22 inches in length; however, these measurements can vary, and any measurement/size can be used.

One or more toy holder(s) 300a, 300b may be provided on the surface 210 of the main body 200 to attach toy(s) thereto. The toy holder(s) 300a, 300b are designed to hold toy(s) while the child plays with them. In FIG. 1, toy holder 300a is shown holding a small stuffed teddy bear 500a, while toy holder 300b is shown holding a baby rattle 500b. The toy holder(s) 300a, 300b can be placed anywhere on the main body 200 and any number of toy holder(s) may be provided. In the embodiments of FIGS. 1-2, the toy holder(s) 300a, 300b are loop(s). The loops may be, for example, ˜4 inches long with ends thereof sewn to the main body 200. The loops may also vary in measurement/size. Further, the loops may be made of an elastic material so as to have a little give when the child pulls on the toy(s).

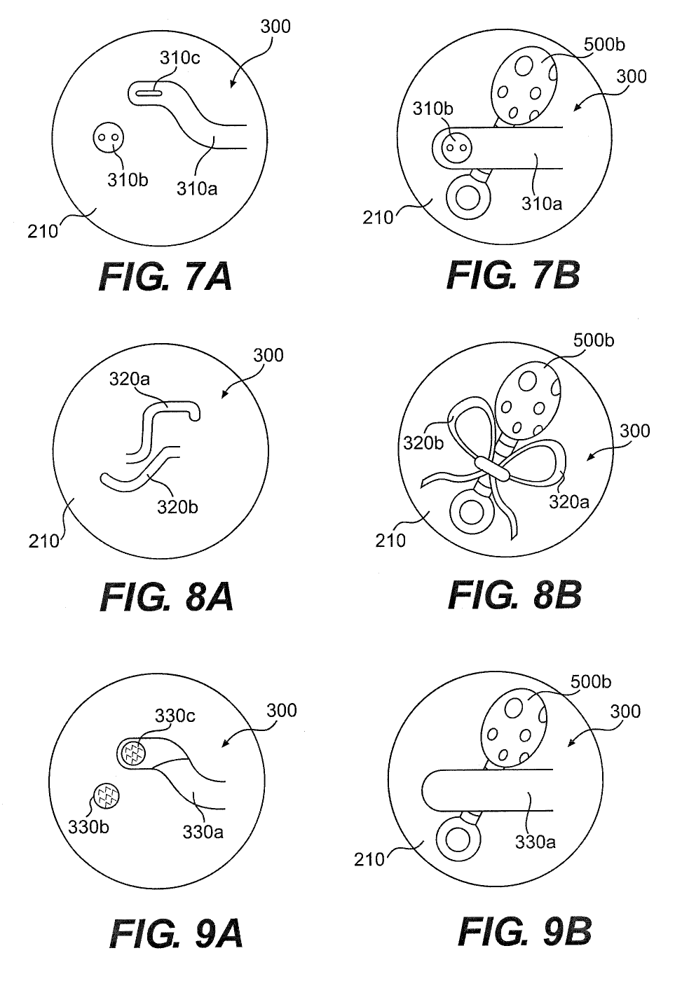

The embodiments of FIGS. 1-2 show loops as the toy holder(s) 300a, 300b; however, other configurations may be appropriate and/or desirable. For example, ties, ribbons, Velcro, buttons, retractable tabs, or other fastening devices may be used as the toy holder(s). For example, FIGS. 7A-11C are partial views (circle A in FIG. 1) of front surfaces of placemats having various style toy holder(s).

FIGS. 7A-7B show an example of a toy holder 300 in the form of an attachment member 310a and a button 310b fixed to a front surface 210 of the placemat 200. One end of the attachment member 310a may include a button hole 310c configured to mate with the button 310b to secure a toy, such as baby rattle 500b, to the placement 200, as shown in FIG. 7B.

FIGS. 8A-8B show an example of a toy holder 300 in the form of a tie or ribbon. Ties or ribbons 320a, 320b may be provided on a front surface 210 of the placemat 200 and may be tied to secure a toy, such as baby rattle 500b, to the placemat 200, as shown in FIG. 8B.

FIGS. 9A-9B show an example of a toy holder 300 in the form of an attachment member 330a attached to a front surface 210 of the placemat 200. Complementary Velcro fastening members 330b, 330c may be provided on the attachment member 330a and the front surface 210 of the placemat 200, respectively. The fastening members 330b, 330c may mate to secure the attachment member 330a and a toy, such as baby rattle 500b, to the placemat 200, as shown in FIG. 9B.

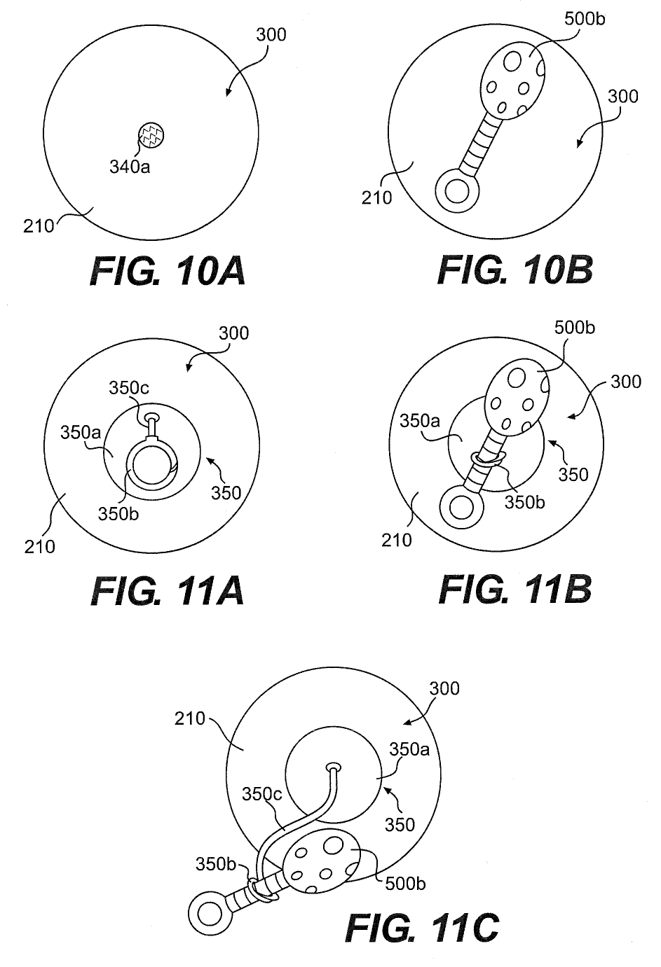

FIGS. 10A-10B show an example of a toy holder 300 in the form of a Velcro fastening member 340a. The Velcro fastening member 340a may be configured to mate with a complimentary Velcro fastening member provided on a toy, such as baby rattle 500b, to secure the toy to the placemat 200, as shown in FIG. 10B.

FIGS. 11A-11C show an example of a toy holder 300 in the form of a retractable tab or clip 350. The retractable tab or clip 350 may include a retractable cable housing 350a, a retractable cable 350c, and a tab or clip 350b attached to the retractable cable 350c. A toy, such as baby rattle 500b, may be attached to the clip 350b to secure the toy to a front surface 210 of the placemat 200 via the retractable cable and housing 350c, 350a, as shown in FIG. 11B. Alternatively, the tab or clip 350b may be in the form of a loop to which a clip of a toy may be attached. The retractable cable 350c may be spring-loaded into the housing 350a in a known fashion, so that the toy may be pulled from the front surface 210 of the placemat 200 for play, as shown in FIG. 11C. Retractable cable 350c will retract into the housing 350a upon release, as shown in FIG. 11B.

The toy holder(s) may be attached to or formed integral with the main body of the placemat. Further, the toy holder(s) may function to hold other items, such as wipe(s), silverware, napkin(s), or other items.

One or more pocket(s) 400 may be provided on the main body 200 to hold and/or store, for example, toy(s), wipe(s), silverware, napkin(s), or other items. Any number of pockets may be provided on the placemat 100 in any location. FIG. 1 shows one pocket 400. In this embodiment, the pocket is ˜5 inches in width and ˜4 inches in length with an opening at the top; however, other measurements, designs, and/or locations for the pocket(s) may be appropriate and/or desirable. The pocket(s) may be attached to or formed integral with the main body of the placemat.

As shown in FIG. 2, attachment device(s) 500a-d may be provided on the rear surface 220 of the main body 200. The attachment device(s) 500a-d attach the placement 100 to a table and prevent slippage. The attachment device(s) may be, for example, suction cups, as shown in FIG. 2. Further, the attachment device(s) 500a-d in FIG. 2 are shown in all four corners of the rear surface 220 of the main body 200; however, other configurations and numbers of attachment device(s) may be appropriate. Further, the attachment device(s) may be attached to or formed integral with the main body of the placemat.

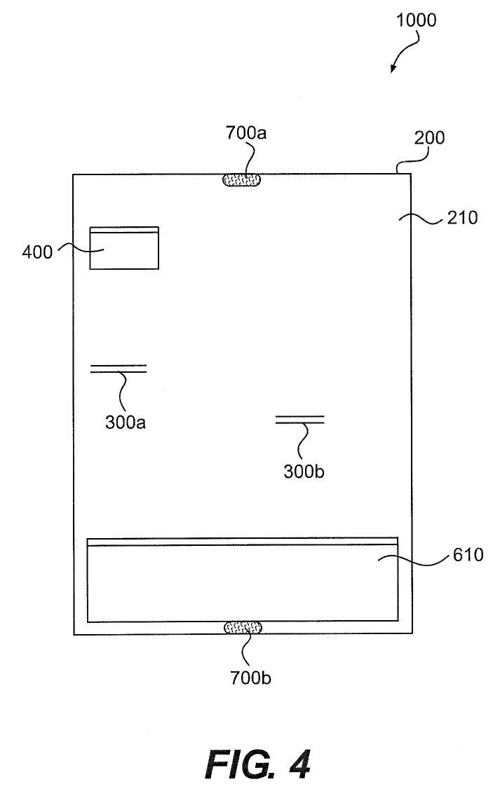

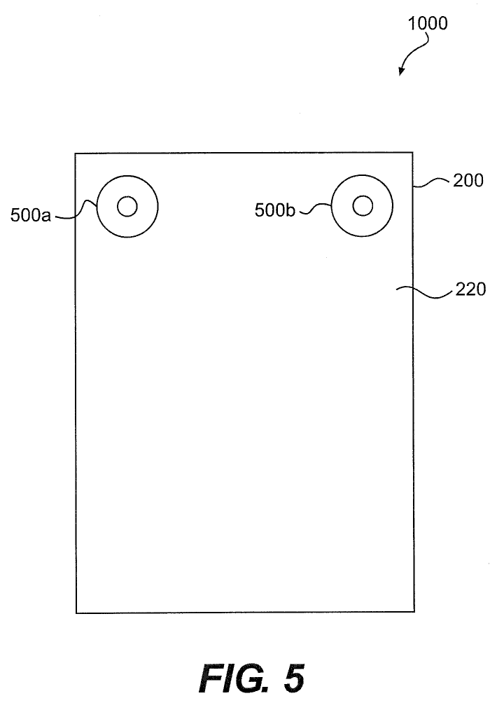

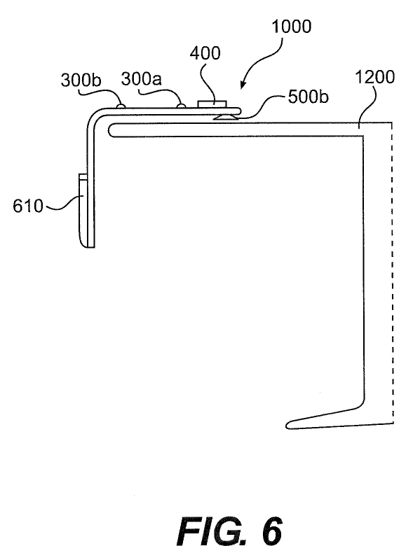

FIG. 4 is a view of a front surface of a placemat with toy holder(s) and/or attachment device(s) according to another embodiment. FIG. 5 is a view of a rear surface of the placemat of FIG. 4. FIG. 6 shows the placemat of FIGS. 4-5 attached to an exemplary table. In the embodiment shown in FIGS. 4-6, the two bottom attachment device(s) 500c, 500d of the placemat 1000 have been eliminated, as shown in FIG. 5, and a pocket 610 has been provided on the front surface 210 of the main body 200 of the placemat 1000. The pocket 610 may run the entire lateral length of the placemat and may be of any width. Further, the pocket 610 may be formed, for example, by folding up an end of the placemat 1000 and attaching it to the front surface 210 or by attaching a separate pocket piece to the front surface 210. This pocket 610 can be used to catch dropped food. With this configuration, the placemat 1000 can hang over the side of the table 1200, as shown in FIG. 6, rather than be fastened to the bottom of the table 1200. The pocket will serve to protect the floor from any dropped food.

The placemat 100, 1000 may be folded or rolled for easy, convenient storage. For storage purposes, one or more fastening device(s) 700a, 700b, such as a Velcro strap, snap, tie(s), or other fastening device(s) may be attached which will be used to keep the placemat 100, 1000 from unrolling while being stored.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A placemat configured to protect a table top, comprising:
a main body having a front surface and a rear surface configured to be placed in contact with a table top; and
one or more toy holders attached to the front surface and configured to hold one or more toys.

2. The placemat of claim 1, wherein the one or more toy holders each comprises a loop.

3. The placement of claim 2, wherein the loop is made of an elastic material.

4. The placemat of claim 1, wherein the one or more toy holders each comprises a pair of ties or ribbons.

5. The placemat of claim 1, wherein the one or more toy holders each comprises an attachment member with button fastener.

6. The placemat of claim 1, wherein the one or more toy holders each comprises an attachment member with Velcro fastener.

7. The placemat of claim 1, wherein the one or more toy holders each comprises a retractable tab.

8. The placemat of claim 1, wherein the one or more toy holders each comprises a Velcro member configured to mate with a corresponding Velcro member provided on a toy.

9. The placemat of claim 1, further comprising:
one or more attachment devices provided on the rear surface configured to secure the placemat in place on the table top.

10. The placemat of claim 9, wherein the main body is configured to wrap around a side edge of a table and the one or more attachment devices secure the placemat to the table top and an underside of the table top.

11. The placemat of claim 9, wherein the one or more attachment devices comprise one of one or more suctions cups, sticky backing, or double sided tape.

12. The placemat of claim 11, wherein the main body is rectangular and the one or more attachment devices comprise a suction cup provided at least two of the four corners of the main body.

13. The placemat of claim 1, wherein the main body is configured to wrap around and protect a side edge of a table in addition to the tabletop.

14. The placemat of claim 1, further comprising at least one pocket provided on a front surface of the main body.

15. The placemat of claim 14, wherein the at least one pocket is provided at one end of the main body and is configured to hang down from the table top.

16. The placemat of claim 1, wherein the main body is formed of a disposable material.

17. The placemat of claim 1, wherein the main body is formed of one of a durable, non-absorbent material which can be wiped down and disinfected after each use or a material coated with a protective layer.

18. The placemat of claim 1, wherein the main body is formed of two layers, a first layer that forms a front surface of the main body and which is fluid absorbent and a second layer that forms the rear surface of the main body and which is fluid repellant.

19. The placemat of claim 1, wherein the placemat is formed of a washable material.

20. The placement of claim 1, wherein the placemat is configured to roll up for storage and further comprises a fastening device configured to secure the placemat in the rolled up state.
